(19) United States
(12) Patent Application Publication
(10) Pub. No.: US 2026/0364697 A1
(43) Pub. Date: Nov. 19, 2026

(54) DEVICE FOR ELECTROCHEMICAL MATERIAL REMOVAL

(71) Applicants: MTU AERO ENGINES AG, Munich (DE); EMAG GMBH & CO. KG, Salach (DE)

(72) Inventors: Kilian Bayer, Munich (DE); Christian Doll, Munich (DE); Matthias Hillmann, Munich (DE); Roland Huttner, Munich (DE); Miriam Rimke, Munich (DE); Robin Göhringer, Salach (DE); Alexander Noller, Salach (DE); Markus Rückle, Salach (DE); Florian Vogel, Salach (DE)

(21) Appl. No.: 19/155,102

(22) PCT Filed: Jan. 29, 2024
(86) PCT No.: PCT/EP2024/052053

§ 371 Date: Aug. 8, 2025

(30) Foreign Application Priority Data
Feb. 9, 2023 (DE) 10 2023 103 148.1

(51) Int. Cl. B23H 7/26; B23H 3/00; B23H 9/10

(52) U.S. Cl. CPC B23H 7/26; B23H 3/00; B23H 9/10

(57) ABSTRACT

The present invention relates to a device for machining a component by electrochemical machining, comprising a component receptacle for arranging the component, and a first machining station, wherein the first machining station and the component receptacle are mounted so as to be rotatable relative to one another about a component axis passing through the component receptacle, and wherein the first machining station comprises a first axis module and a first tool carrier, wherein a first machining electrode for machining the component by electrochemical machining is or can be arranged on the first tool carrier, and wherein the first tool carrier is mounted on the first axis module so as to be rotatable about a first tool axis, wherein the first tool axis is at an angle to the component axis of the component receptacle.

### TECHNICAL FIELD

The present invention relates to a device for machining a component by electrochemical machining.

### PRIOR ART

During the electrochemical machining, a working gap is set between the component and the tool, i.e. the machining electrode, wherein the component is then polarized as an anode and the tool is polarized as a cathode. As a result of the contactless machining in this respect, comparatively hard materials can thus also be machined in a material-removing manner, for which reason the method and corresponding devices can advantageously be used in the manufacture of components for axial turbomachines, in particular aircraft engines.

Such a machining device comprises, on the one hand, a component receptacle, in which the component is arranged for machining, and a machining station having the machining electrode. Since the machining station and the component receptacle are mounted so as to be rotatable relative to one another about a component axis, typically the component can be rotated with the component receptacle when viewed in a stationary coordinate system, different points of the component can be machined sequentially in this case using the same machining station. An identical or comparable contour can thus be introduced successively at different points, for instance at different rotational positions. This is intended to illustrate a preferred application environment, but at first not to limit the subject matter in its generality.

### SUMMARY OF THE INVENTION

The present invention is based on the technical problem of specifying an advantageous device for machining a component by electrochemical machining.

This is achieved according to the invention by the device according to Claim 1. In the device, a first machining station comprises a first axis module and a first tool carrier, on which the machining electrode is or can be arranged. Therein, the first tool carrier is mounted on the axis module so as to be rotatable about a first tool axis, wherein this tool axis is at an angle to the component axis. If, for example, in the application described above, an airfoil of a vane or blade ring is machined in a material-removing manner, the angle of attack thereof can thus be adjusted (in relation to the incident flow, that is to say the operation in the gas channel). Thus, airfoils having a different angle of attack can be manufactured with the same machining station, that is to say in particular different vane or blade rings can be manufactured on the same device.

If, for illustration, the manufacture of a so-called blisk (blade integrated disc, blisk) is considered, the machining electrode can be moved toward the suction or pressure side surface thereof for contouring the airfoil, cf. FIG. 4 for illustration. As a result of the rotatability about the tool axis, the direction of this relative movement in relation to the component axis, and since this typically coincides with the rotational or longitudinal axis of the turbomachine, can thus also be changed relative to the axial direction of the turbomachine (so that the angle of attack is adjustable).

A further or alternative advantage of the rotatability about the tool axis can result, for example, to the effect that different types of machining can be realized with the same machining station. Thus, in turn in relation to a blisk, with the machining station, for example in a first step, a recess can be introduced between two airfoils, which may also be referred to as “roughing”. Subsequently, with the same machining station or the same tool carrier, as a result of the rotatability about the tool axis, the side surface of the airfoil can also be defined in detail, which may be referred to as “finishing”. As a result of the rotatability of the tool carrier about the tool axis, different types of machining can thus be realized, for which purpose possibly only the machining electrode has to be replaced, but the axis module and the tool carrier can remain un-changed (which reduces the set-up effort).

Preferred embodiments are presented in the dependent claims and the entire disclosure, wherein in the description of the features, a distinction is not always made in detail between device aspects and method aspects or use aspects; in any case, the disclosure is to be read implicitly with regard to all claim categories. If, for example, a machining device suitable for a specific operation is described, this is to be understood at the same time as a disclosure of a corresponding method of operating, and vice versa.

The first tool axis is “at an angle” to the component axis, i.e. not parallel thereto, but at an angle (obliquely or also perpendicularly). The first machining station and the component receptacle are rotatable relative to one another about the component axis, wherein the machining station preferably rests and the component receptacle is rotated when viewed in a stationary coordinate system during the relative rotation. Also independently of how the relative rotation is realized in detail, a plurality of machining stations can preferably be arranged at different rotational positions about the component axis, i.e. the component can be machined simultaneously at different rotational positions (see below in detail). As mentioned above, if the component is preferably provided for a turbomachine, in particular an aircraft engine, the component axis can preferably coincide with the longitudinal axis thereof. If the component is designed as a rotor or a component thereof, the component axis preferably coincides with the rotational axis thereof.

A first tool axis direction, which by definition is parallel to the first tool axis, is perpendicular to the component axis in a preferred embodiment. Since, as explained in detail below, a further rotatability of the axis module is possible, the component axis and the tool axis do not necessarily have to intersect; as a result of the rotatability of the axis module, the tool axis can be movable in a plane to which the component axis is preferably perpendicular.

According to a preferred embodiment, the first machining electrode is mounted on the first tool carrier so as to be translationally displaceable, namely on a first tool carrier translation axis. This is at an angle to the first tool axis; it is preferably perpendicular thereto. With the movability of the machining electrode along the tool carrier translation axis, the distance of the machining electrode from the tool axis can be changed; this can be moved toward the tool axis or away therefrom. If, for example, an airfoil is contoured with the material-removing machining, the tool carrier translation axis can be substantially perpendicular to the suction or pressure side surface thereof during the machining.

In a preferred embodiment, as already mentioned, the first axis module is mounted so as to be rotatable about a first axis module rotation axis; this axis preferably passes through the first axis module. As a result of this rotatability of the axis module “in it-self”, it can be set obliquely relative to the component, in particular in combination with an additional translational displaceability (see below). Thus, for example, the rotational offset (angle of rotation) relative to a second machining station can be adapted, which makes possible, for example, an application in the case of a disk or blisk having an odd number of airfoils. The embodiment “axis module mounted so as to be rotatable about a first axis module rotation axis” shall also be disclosed independently of the tool carrier mounted on the axis module so as to be rotatable about the first tool axis; nevertheless, combinations with other variants described herein are possible.

In a preferred embodiment, the axis module rotation axis is parallel to the component axis. The first tool axis is at an angle to the axis module rotation axis; it is preferably perpendicular thereto.

According to a preferred embodiment, which can be combined in particular with the rotatability about the axis module rotation axis, the first axis module is mounted on a first translation axis so as to be translationally displaceable relative to the component receptacle. It is preferably additionally mounted on a second translation axis so as to be translationally displaceable. The first and second translation axes together span a translation plane; they are preferably perpendicular to one another. The axis module rotation axis passes through the translation plane at an angle, preferably perpendicularly.

In conjunction with the rotatability about the axis module rotation axis, the displaceability in the translation plane can allow a change in the rotational position, on which the axis module is located relative to the component or to the component receptacle, with simultaneous adaptation of the angle of attack; that is to say in particular an adaptation as a function of an even/odd number of airfoils is possible. This could alternatively also be achieved, for example, with an axis module mounted on an arc segment so as to be pivotable about the component axis, which would, however, require a correspondingly more complex arc mechanism.

In comparison thereto, the combination of translation plane and rotatability can be realized with drives and structures available as standard, which can be advantageous, for example, for economic reasons and also with regard to the reliability and availability of spare parts, etc. Furthermore, the combination of translation and rotational offset can also allow, for example, an “oblique threading”, which can be advantageous, for example, in the case of airfoils having a “tilt”, in which the threading axis is thus at least in sections not aligned in the direction of the longitudinal/rotation axis of the component, but rather, for example, tilts away in a radially outer section.

In a preferred embodiment, the machining device comprises a second machining station, wherein the first and second machining stations are arranged at different rotational positions about the component axis. In general, there can also be further machining stations, that is to say a total of, for example, at least three or four machining stations (with possible upper limits at, for example, at most eight or six); however, precisely two machining stations are particularly preferably provided. Said machining stations are preferably placed on mutually opposite sides of the component receptacle, particularly preferably rotated by 180° with respect to one another (in relation to their respective basic position, neglecting an adjustment by translation/rotational offset).

In a preferred embodiment, the second machining station also comprises an axis module and a tool carrier, which may be referred to herein as “second axis module” and “second tool carrier”. A second machining electrode is or can be arranged on the second tool carrier, preferably
the second tool carrier is mounted on the second axis module so as to be rotatable about a second tool axis, wherein the second tool axis is at an angle to the component axis, and/or
the second axis module is mounted so as to be rotatable about a second axis module rotation axis which passes through the second axis module (and is preferably parallel to the component axis), wherein the second axis module is additionally preferably mounted on a first and a second translation axis so as to be displaceable, which together span a second translation plane (which passes through the component axis, preferably perpendicularly).

Generally, all variants disclosed with regard to the first machining station shall also be disclosed as preferred with regard to the second machining station. In a preferred embodiment, the first and second machining stations are structurally identical to one another, i.e. they are constructed identically.

With regard to the orientation of the device when viewed in a stationary coordinate system, standing installation would generally also be possible, i.e. the component axis could be horizontal. However, a bed construction is preferred, i.e. the component axis is parallel to the vertical. The translation plane or planes can then preferably each be horizontal; the same applies to the tool axis or axes.

The invention also relates to a method for machining a component using a device disclosed herein, in the component receptacle of which the component is arranged. The component is then machined in a material-removing manner using the first machining electrode, for which purpose the latter is polarized as a cathode and the component is polarized as an anode. After the machining at a first position, the component can be rotated relative to the (first) machining station; subsequently, it can be machined in a material-removing manner using the first machining electrode at a second position.

In this way, the component can be machined successively at a plurality of positions using the first machining electrode. Preferably, the component, when it is machined in a material-removing manner using the first machining electrode, is simultaneously machined in a material-removing manner using the second machining electrode. The component is thus machined simultaneously at the different machining stations, which can increase the throughput. Preferably, in this case, different angles of rotation (about the component axis) from machining station to machining station can be set from component to component, for example as a function of the number of airfoils thereof (even/odd), to be precise via the offset in the translation plane and the rotation about the axis module rotation axis.

The invention further relates to a method for manufacturing a component for a turbomachine, wherein said component is machined in a material-removing manner in a manner described herein. The component is preferably a blisk.

### BRIEF DESCRIPTION OF THE DRAWINGS

The invention is explained in more detail below on the basis of an exemplary embodiment, wherein the individual features can also be of interest for the invention in another combination within the scope of the independent claims, and furthermore, a distinction is also not made in detail between the different claim categories.

In detail,

FIG. 1 shows a device according to the invention for machining a component by electrochemical machining in a schematic plan view;

FIG. 2 shows the device according to FIG. 1 in a schematic side view;

FIG. 3 shows an aircraft engine in a schematic longitudinal section for illustration of a typical field of application of a component manufactured using the device according to FIGS. 1 and 2;

FIG. 4 shows a schematic radial view in the manufacture of a blisk.

### PREFERRED EMBODIMENT OF THE INVENTION

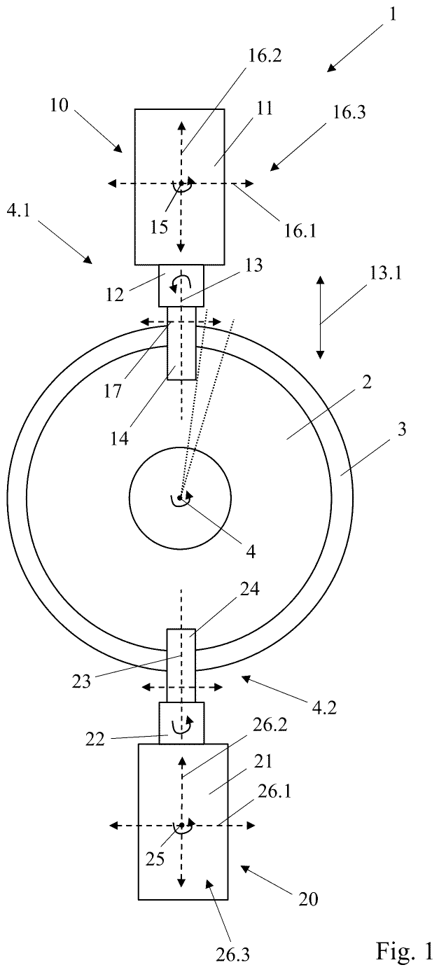

FIG. 1 shows a device 1 for machining a component 2 by electrochemical machining. The component 2 is arranged in a component receptacle 3, in which it is rotatable about a component axis 4 perpendicular to the drawing plane. A first machining station 10 and a second machining station 20 are arranged at different rotational positions 4.1, 4.2.

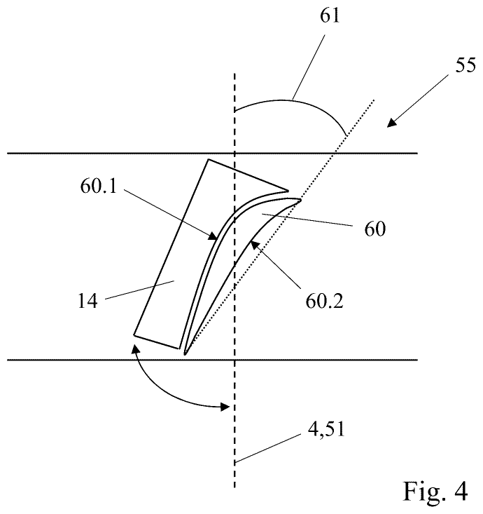

The first machining station 10 comprises a first axis module 11 and a first tool carrier 12, wherein the first tool carrier 12 is mounted on the first axis module 11 so as to be rotatable about a tool axis 13. The first tool axis 13 is parallel to the drawing plane; a first tool axis direction 13.1 parallel thereto is perpendicular to the component axis 4. A first machining electrode 14 is arranged on the first tool carrier 12. Said machining electrode can be rotated about the first tool axis 13, which allows the adjustment of different angles of attack, cf. FIG. 4 for illustration.

The first axis module 11 is further mounted so as to be rotatable about a first axis module rotation axis 15 which passes through the first axis module 11 and is perpendicular to the drawing plane in the present case. It is further mounted on a first translation axis 16.1 and a second translation axis 16.2 in each case so as to be translationally displaceable. The two translation axes 16.1, 16.2 together span a translation plane 16.3 which is parallel to the drawing plane in the present case. With the displaceability in the translation plane 16.3 and the rotatability about the first axis module rotation axis 15, the first axis module 11 can be set relative to the component receptacle 3 such that the machining electrode 14 can be positioned at a different angle of rotation/a different rotational position (offset to the left or right), but in the process at the same angle to the component axis 4, cf. the dashed lines for illustration. Thus, different components 2, in particular having both an even and an odd number of airfoils, can be manufactured with the same device 1.

In addition to the kinematics described up to now, the machining electrode 14 is mounted on the first tool carrier 12 so as to be translationally displaceable on a first tool carrier translation axis 17. Thus, the machining electrode 14 can be set tangentially offset in relation to the component 2, that is to say in the circumferential direction. The orientation of the first tool carrier translation axis 17 relative to the component axis 4 can be changed with the rotation about the first tool axis 13.

The second machining station 20 comprises a second axis module 21 and a second tool carrier 22, which is mounted on the second axis module 21 so as to be rotatable about a second tool axis 23. Furthermore, the second axis module 21 is mounted so as to be rotatable about a second axis module rotation axis 25, and on a first and second translation axis 26.1, 26.2 so as to be displaceable in a second translation plane 26.3. Thus, the second machining electrode 24 can also be set obliquely or at different angular positions. The second machining station 20 is structurally identical to the first machining station 10; with regard to further details, reference is made to the above description.

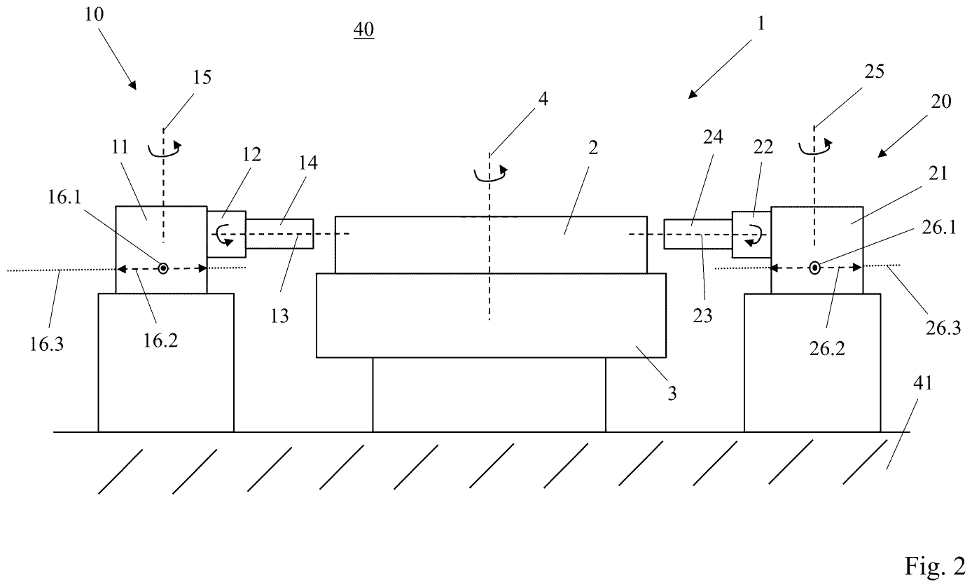

FIG. 2 shows the device according to FIG. 1 in a side view, specifically looking at the device 1 from the left-hand side in relation to FIG. 1. The individual components and axes are provided with the same reference signs as in FIG. 1; with regard to the respective function, reference is made to the above description. In relation to a stationary coordinate system 40, the device 1 can be placed on the floor 41 as illustrated, i.e. the component axis 4 and axis module rotation axes 15, 25 can be vertical. The translation planes 16.3, 26.3 are each horizontal.

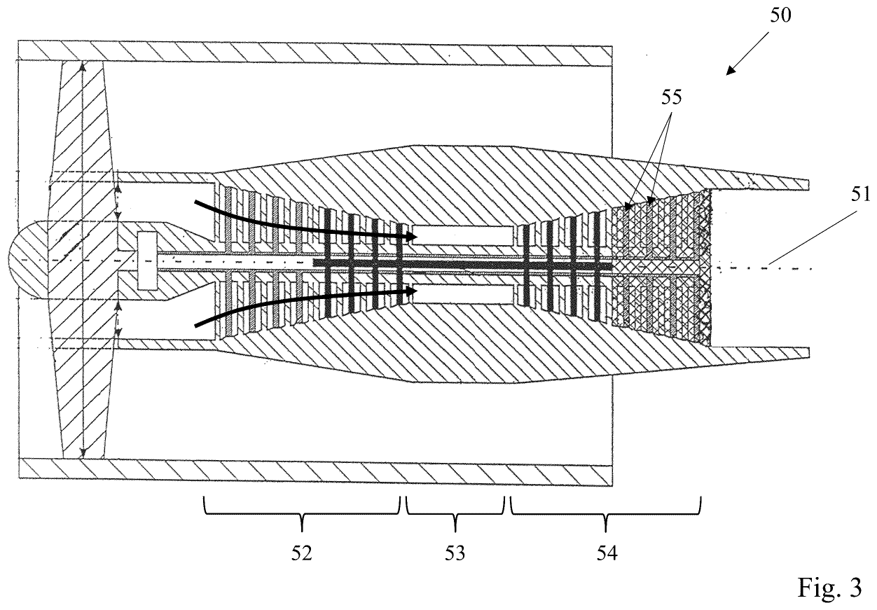

FIG. 3 shows a turbomachine 50, specifically a turbofan engine, in a schematic axial section, i.e. when viewed in a sectional plane containing its rotation axis 51. Functionally, the turbofan engine is divided into compressor 52, combustion chamber 53 and turbine 54, wherein air sucked in during operation is compressed in the compressor 52 and combusted with added fuel in the downstream combustion chamber 53. The resulting hot gas then expands in the turbine 54 and thus drives the rotors thereof. These can be designed in part as a blisk 55, such a blisk 55 can be manufactured in a device according to FIGS. 1 and 2.

FIG. 4 shows the manufacture of a blisk 55 in a schematic radial view, i.e. looking at it from the outside radially in relation to the rotation axis 51. The rotation axis 51 coincides with the component axis 4, an airfoil 60 is further illustrated schematically, the suction and pressure side surface 60.1, 60.2 thereof being contoured with the machining electrode 14 during the material-removing machining. As a result of the rotatability about the tool axis 13, airfoils 60 having a different angle of attack 61 can be manufactured.

### REFERENCE NUMERALS

Device 1
component 2
component receptacle 3
component axis 4
rotational positions 4.1-4.2
machining stations 10, 20
axis modules 11, 21
tool carrier 12, 22
machining electrode 14, 24
first tool axis 13
tool axis direction 13.1
axis module rotation axis 15
translation axis 16.1-16.2
translation plane 16.3
tool carrier translation axis 17
machining station 20
coordinate system 40
turbomachine 50
blisk 55

1. Device for machining a component by electrochemical machining, comprising
a component receptacle for arranging the component, and
a first machining station,
wherein the first machining station and the component receptacle are mounted so as to be rotatable relative to one another about a component axis passing through the component receptacle,
and wherein the first machining station comprises a first axis module and a first tool carrier,
wherein a first machining electrode for machining the component by electrochemical machining is or can be arranged on the first tool carrier, and wherein the first tool carrier is mounted on the first axis module so as to be rotatable about a first tool axis, wherein the first tool axis is at an angle to the component axis of the component receptacle.

2. Device according to claim 1, in which a first tool axis direction, which is parallel to the first tool axis, is perpendicular to the component axis of the component receptacle.

3. Device according to claim 1, in which the first machining electrode is mounted on the first tool carrier so as to be translationally displaceable on a first tool carrier translation axis, wherein the first tool carrier translation axis is at an angle to the first tool axis.

4. Device according to claim 1, in which the first axis module is mounted so as to be rotatable about a first axis module rotation axis which passes through the first axis module.

5. Device according to claim 4, in which the first axis module rotation axis is parallel to the component axis.

6. Device according to claim 1, in which the first axis module is mounted on a first translation axis so as to be translationally displaceable relative to the component receptacle, wherein the first translation axis is at an angle to the component axis.

7. Device according to claim 6, in which the first axis module is mounted on a second translation axis so as to be translationally displaceable relative to the component receptacle, wherein the first and second translation axes together span a translation plane.

8. Device according to claim 7, in which the first axis module is mounted so as to be rotatable about a first axis module rotation axis which passes through the first axis module, and in which the first axis module rotation axis is perpendicular to the translation plane.

9. Device according to claim 1, having
a second machining station,
wherein the first and the second machining station are arranged at different rotational positions in relation to the component axis.

10. Device according to claim 9, in which the second machining station comprises a second axis module and a second tool carrier, on which a second machining electrode for machining the component by electrochemical machining is or can be arranged.

11. Device according to claim 10, in which the first and the second machining station are structurally identical to one another.

12. Device according to claim 1, in which the component axis is vertical when viewed in a stationary coordinate system.

13. Method for machining a component using a device according to claim 1, in which
a component is arranged in the component receptacle, and
the component is machined by electrochemical machining using a first machining electrode which is arranged on the first tool carrier.

14. Method for manufacturing a component, in which the component is machined in a method according to claim 13.

15. Method according to claim 14, in which the component is a component for a turbomachine, in particular a blisk.
